(19) United States
(12) Patent Application Publication
(10) Pub. No.: US 2016/0280530 A1
(43) Pub. Date: Sep. 29, 2016

(54) Counter Edge Water Bottle Dispenser

(71) Applicant: Kenneth John Gallagher, Las Vegas, NV (US)

(72) Inventor: Kenneth John Gallagher, Las Vegas, NV (US)

(21) Appl. No.: 15/066,126

(22) Filed: Mar. 10, 2016

Related U.S. Application Data
(60) Provisional application No. 62/137,577, filed on Mar. 24, 2015.

(51) Int. Cl. B67D 3/00

(52) U.S. Cl. CPC B67D 3/0035; B67D 3/0038; B67D 3/0061

(57) ABSTRACT

A dispenser for delivering a liquid from an inverted supply bottle has a walled base. The walled base of the dispenser is coupled to the inverted supply bottle. The walled base has an interior reservoir. The interior reservoir is in liquid communication with the inverted supply bottle. The interior reservoir stores a predetermined quantity of the liquid transferred from the inverted supply bottle. A valve is attached to the bottom of the walled base. The valve is in liquid communication with the interior reservoir. The valve controls a flow of the liquid through the interior reservoir from the inverted supply bottle. The valve delivers the liquid from the interior reservoir to a location outside of the walled base.

### CROSS REFERENCE TO RELATED APPLICATIONS

The present application claims the benefit of U.S. Provisional Application No. 62/137,577 filed on 2015 Mar. 24 titled “COUNTER EDGE WATER BOTTLE DISPENSER” in the name of Kenneth J. Gallagher, and which is incorporated herein by reference in its entirety.

### BACKGROUND OF THE DISCLOSURE

The present application generally relates to a bottled water dispenser, and, more particularly, to water bottle holders and water bottle dispensers that provide a convenient and simplified mechanism to access bottled water in a direct manner.

With the advent of increased popularity of bottled spring water and bottled purified water here and abroad, a need may have developed for water bottle holders and water bottle dispensers that may provide a convenient and simplified mechanism to access bottled water. In the past, water may have been dispensed through a water crock or similar devices. Water crocks may be jars or containers that store water. A dispensing device may be located at the bottom of the water crock for releasing water stored within the container. Water crocks generally require filling prior to usage and generally need to be cleaned periodically. Water dispensers have evolved from the simple water crocks to bottled water dispensers ranging from the original multiple gallon glass jugs that were inverted and positioned within large free standing and often refrigerated water coolers to the more current, disposable plastic bottles and single use “gallon” plastic water jugs.

A limited number of companies offer purified and spring water in countertop plastic water jug dispensers. These plastic water jugs may have a single use valve that may be located at the bottom of the jug. Of the few brands that do offer a countertop dispenser version of their product, several problems may be associated with their dispensers. The single use valves that may be offered with the limited number of branded countertop dispensers that are on the market may be of a low quality and may often leak. Lastly, these dispensers may present a number of practical placement and use restrictions and problems.

Over the years, a variety of U.S. patents have issued on dispensing valves/valve parts, and water dispensing devices. U.S. Pat. No. 4,293,082 issued to Shinji Matsueda shows one way in which an inverted bottle can be supported by a stand that includes a thermal insulator for the inverted bottle. U.S. Pat. No. 5,123,720 issued to Blomster et al. discloses a floor based inverted water bottle stand for a 5 gallons bottle. As with the Shinji patent, the Bolomster et al. is patenting the stand that supports an inverted bottle. U.S. Pat. No. 5,647,416 issued to Desrosiers et al. discloses another patent on a stand for a 5 gallons bottle that includes a reservoir and the support housing for the reservoir.

U.S. Pat. No. 6,241,126 issued to Andrew Goodman discloses a personal beverage desktop dispenser with a cubical base and valve housed therein. The male bottle threads are mated with the female threads of the base. An issue with this embodiment is that it may be difficult to invert the entire dispenser to union it with the upright bottle since the bottle valve is secured to the base. Even if the valve was not secured to the base, the valve with the handle is too large to fit through the bottle hole in the base top. It could prove rather difficult to threadably secure an entire base onto a bottle. Moreover, the base could become unsanitary rather quickly having liquid spilled within the base and it appears to be rather difficult to clean.

U.S. Pat. No. 6,527,145 issued to Jules G. Bennett, Jr. discloses a personal desktop beverage dispenser that has a base holding an inverted bottle with the bottle male threads threadably secured to the female threads of the dispenser base. An outflow valve controls the flow of bottle contents to a cup placed beneath. While this embodiment can be used with more than one bottle size, it requires having to invert an entire base that is rather large in size, and threadably secure it onto an upright bottle, which could prove to be rather difficult.

U.S. Pat. No. 6,892,903 issued to Salvatore Barolotta discloses a personal beverage bottle dispenser. The personal beverage bottle dispenser again requires that a rather large base be inverted and threadably secured to the upright bottle in order to union the bottle with the valve.

U.S. Pat. No. 3,104,089 issued to Harold O. Seltsam, shows a self-closing lift type faucet adapted for use with water crocks, certain coolers, and beverage dispensers. Similarly, U.S. Pat. No. 3207,472 issued Sep. 25, 1965 to Seltsam shows a tubular diaphragm valve. As with the self-closing valve, this valve is again configured for use with water crocks, certain coolers, and beverage dispensers.

### SUMMARY OF THE DISCLOSURE

In accordance with one embodiment, a dispenser for delivering a liquid from an inverted supply bottle is disclosed. The dispenser has a walled base. The walled base of the dispenser is coupled to the inverted supply bottle. The walled base has an interior reservoir. The interior reservoir is in liquid communication with the inverted supply bottle. The interior reservoir stores a predetermined quantity of the liquid transferred from the inverted supply bottle. A valve is attached to the bottom of the walled base. The valve is in liquid communication with the interior reservoir. The valve controls a flow of the liquid through the interior reservoir from the inverted supply bottle. The valve delivers the liquid from the interior reservoir to a location outside of the walled base.

In accordance with one embodiment, a dispenser for delivering a liquid from an inverted supply bottle is disclosed. The dispenser has a walled base. The walled base of the dispenser is coupled to the inverted supply bottle with a union. The walled base has an interior reservoir. The interior reservoir is in liquid communication with the inverted supply bottle. The interior reservoir stores a predetermined quantity of the liquid transferred from the inverted supply bottle. A valve is attached to the bottom of the walled base. The valve is in liquid communication with the interior reservoir. The valve controls a flow of the liquid through the interior reservoir from the inverted supply bottle. The valve delivers the liquid from the interior reservoir to a location outside of the walled base.

In accordance with one embodiment, a dispenser for delivering a liquid from an inverted supply bottle is disclosed. The dispenser has a walled base. The walled base of the dispenser has a threaded top. The threaded top of the walled base is threadably secured to the inverted supply bottle with a union. The walled base has an interior reservoir. The interior reservoir is in liquid communication with the inverted supply bottle. The interior reservoir stores a predetermined quantity of the liquid transferred from the inverted supply bottle. A valve is attached to the bottom of the walled base. The valve is in liquid communication with the interior reservoir. The valve controls a flow of the liquid through the interior reservoir from the inverted supply bottle. The valve delivers the liquid from the interior reservoir to a location outside of the walled base.

### BRIEF DESCRIPTION OF THE DRAWINGS

In the descriptions that follow, like parts are marked throughout the specification and drawings with the same numerals, respectively. The drawing figures are not necessarily drawn to scale and certain figures may be shown in exaggerated or generalized form in the interest of clarity and conciseness. The disclosure itself, however, as well as a preferred mode of use, further objectives and advantages thereof, will be best understood by reference to the following detailed description of illustrative embodiments when read in conjunction with the accompanying drawings, wherein:

FIG. 1 is a perspective side view of an exemplary water bottle dispenser coupled to a water bottle;

FIG. 2 is a perspective side view of the exemplary water bottle dispenser;

FIG. 3 is a perspective side view of the exemplary dispenser coupled to a water bottle;

FIG. 4—is an exploded view of the exemplary water bottle dispenser coupled to the water bottle of FIG. 3;

FIG. 5 is a top view of the exemplary water bottle dispenser of FIG. 2;

FIG. 6 is a sectional view of the exemplary water bottle dispenser shown in FIG. 5 taken at the sectioning plane in the direction indicated by section lines 6-6;

FIG. 7 is a broken orthogonal side view of the exemplary water bottle dispenser of FIG. 2;

FIG. 8 is a broken orthogonal side view of the exemplary water bottle dispenser of FIG. 2;

FIG. 9 is broken orthogonal side view illustrating the valve portion of the exemplary water bottle dispenser of FIG. 2;

FIG. 10 is a sectional view of FIG. 9 taken at the sectioning plane in the direction indicated by section lines 10-10;

FIG. 11 is a perspective view of an exemplary bottle union used with the exemplary water bottle dispenser in accordance with one aspect of the present application;

FIG. 12 is a perspective view of an exemplary bottle union used with the exemplary water bottle dispenser in accordance with one aspect of the present application; and

FIG. 13 is a perspective view of an exemplary bottle union used with the exemplary water bottle dispenser in accordance with one aspect of the present application.

### DETAILED DESCRIPTION OF THE DISCLOSURE

The description set forth below in connection with the appended drawings is intended as a description of a present embodiment of the disclosure and is not intended to represent the forms in which the present disclosure may be constructed and/or utilized. The description sets forth the functions and the sequence of steps for constructing and operating the disclosure in connection with the illustrated embodiment. It is to be understood, however, that the same or equivalent functions and sequences may be accomplished by different embodiments that also are intended to be encompassed within the spirit and scope of this disclosure.

Accordingly, there are one or more aspects to the present water bottle dispenser that offers advantages over the current existing methods that are being used to serve people water. Embodiments of the disclosure provide a water bottle dispenser that may allow water to be accessed directly from single use water bottles for use with the water bottle dispenser, with no transfer of water to a container required.

In accordance with an embodiment, the dispenser base may be threadably secured to an upright water bottle. The installation of the dispenser base onto the upright water bottle may be completed quickly as the dispenser base may be easily handled and coupled to the upright water bottle. A valve may control a flow of water from the water bottle when the water bottle is inverted and coupled to the dispenser base. In accordance with the embodiment, the valve may have a reservoir in an interior of a walled base of the dispenser that may store a predetermined quantity of water transferred from the water bottle coupled to the dispenser. The transfer of water may drop the water level in the inverted water bottle to a predetermined level. The dropped water level may allow for a vent hole to be administered in the water bottle without water (hereinafter liquid) escaping out of the vent hole.

Lastly, the valve may be an improvement over the “one-off” valves that are commonly used with countertop dispensers, so the quality and life of the valve may be better, and the valve may be less likely to leak. The above advantages of one or more aspects of the water bottle dispenser will become apparent upon reflection of the disclosure set forth below.

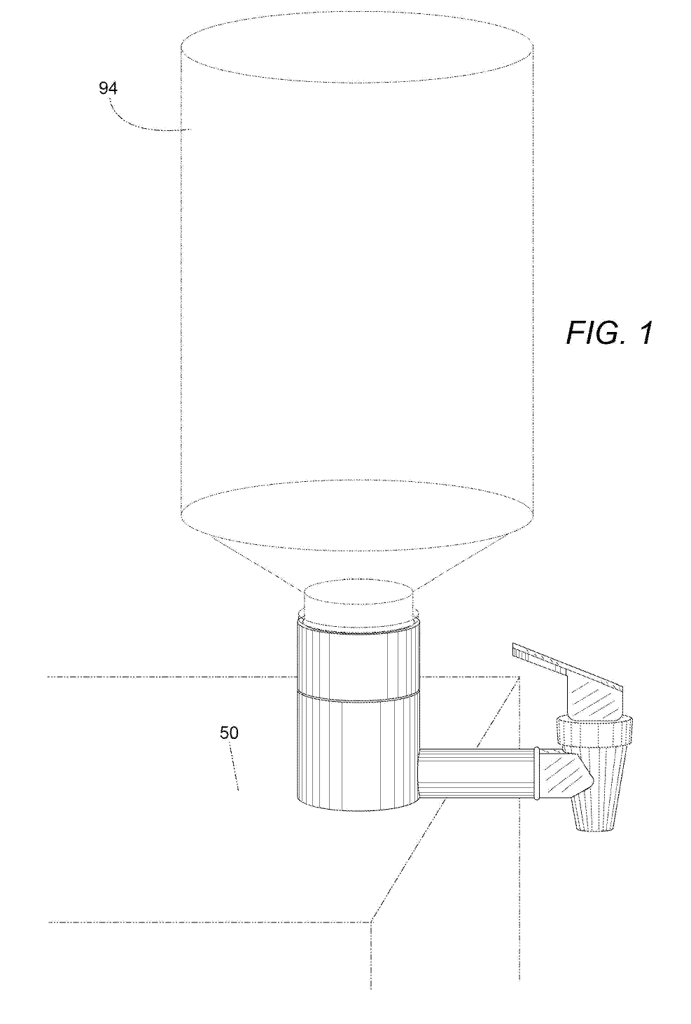

Referring to FIG. 1, a perspective of the water bottle dispenser (hereinafter dispenser) may be shown resting on a counter 50.

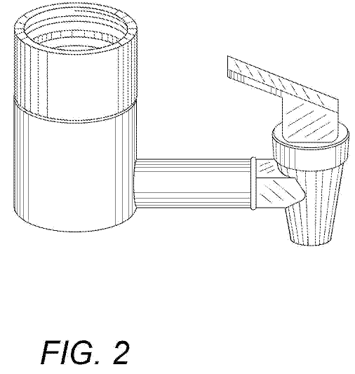

Referring to FIG. 2, a perspective view of the dispenser may be seen.

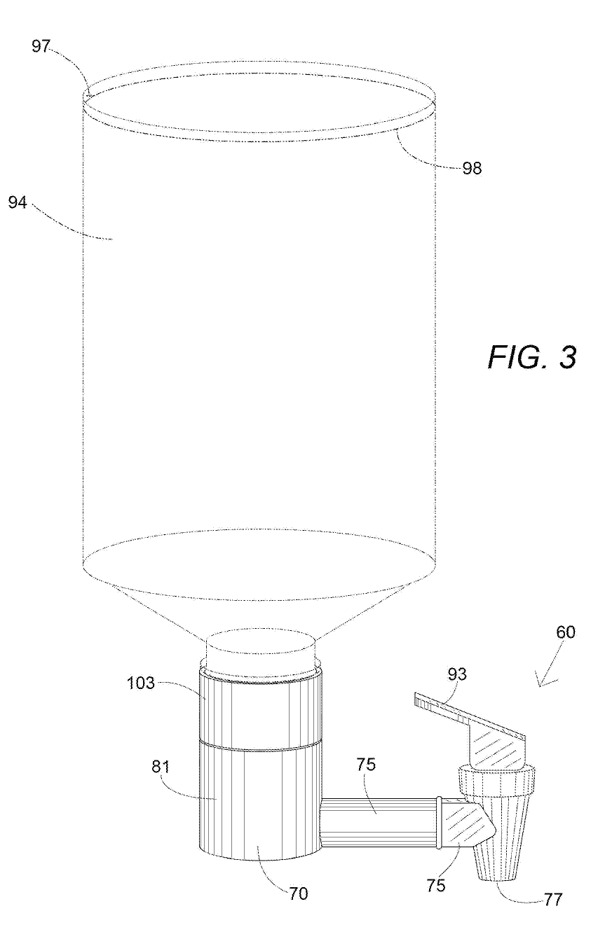

Referring to FIG. 3, a perspective side view of the dispenser is shown. The dispenser may have a walled base 70 (hereinafter base 70). The base 70 may have an interior reservoir 81 (hereinafter reservoir 81). The base 70 of the dispenser may be coupled to an inverted supply bottle 94 (hereinafter supply bottle 94) with a union 103. In the present embodiment the base 70 may be cylindrical in shape. However, only one example is illustrated, and the base 70 may be offered in a number of other geometrical shapes and sizes. The base 70 may be constructed of a durable plastic such as polypropylene or of a metal such as stainless steel. The dispenser may have a valve body 75. In the present embodiment a portion the valve body may be cylindrical in shape. However, only one example is illustrated, and the cylindrical portion of the valve body 75 may be offered in a number of other geometrical shapes and sizes. The valve body 75 may be constructed of a durable plastic such as polypropylene or of a metal such as stainless steel. The dispenser may have a valve 60. The valve 60 may be attached to the bottom of the base 70. The valve 60 may be in liquid communication with the reservoir 81 of the base 70, and the reservoir 81 may be in liquid communication with the supply bottle 94. The valve 60 may control a flow of a liquid through the reservoir 81 from the supply bottle 94. The valve 60 may deliver the liquid from the interior reservoir 81 to a location outside of the base 70. The valve 60 may require that prior to usage, a vent hole 97 be administered to the supply bottle 94. The vent hole 97 may be necessary in order for the liquid from the supply bottle 94 to flow adequately through the valve 60 and out of a valve body outlet port 77 when a valve activation lever 93 is activated. The reservoir 81 may allow for a transfer of a predetermined amount of the liquid from the supply bottle 94 into the reservoir 81. The transfer of the liquid may drop a liquid level 98 in the supply bottle 94 to a predetermined level. The dropped liquid level 98 may allow for the vent hole 97 to be administered to the supply bottle 94 without the liquid in the supply bottle 94 escaping through vent hole 97.

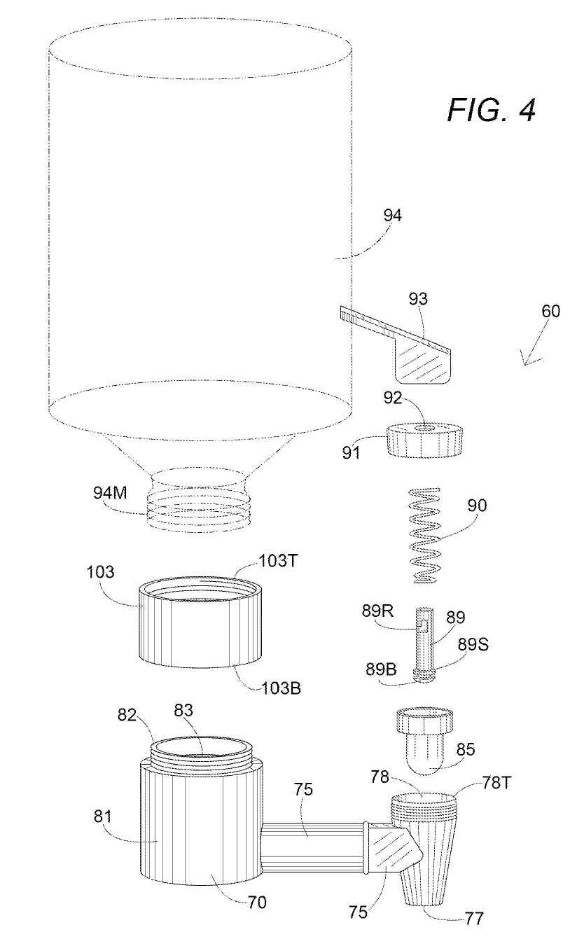

Referring to FIG. 4, and an exploded view of FIG. 3 may be seen. In FIG. 4 the supply bottle 94 and the valve 60 of the dispenser are illustrated. The valve 60 may have an assembly of parts including the valve body 75, a rubber seat cup 85, a peg 89, a coil spring 90, a component compartment bonnet 91 and the valve activation lever 93. A union bottom 103B of the bottle union 103 may be threadably secured to a threaded base top 82, and a bottle mouth 94M of the supply bottle 94 may be threadably secured to a bottle union top 103T of the bottle union 103. A base inlet port 83, the base reservoir 81, and the valve body outlet port 77 of the valve body 75 may be in liquid communication with one another. The valve 60 may deliver the liquid from the supply bottle 94 to location outside of the walled base 70. A component compartment 78 of the valve body 75, the seat cup 85, and a peg base 89B of the peg 89 may be seen. The peg base 89B may anchor into the seat cup 85. A spring base 89S is where the coil spring 90 may rest when the valve 60 is assembled. A right pin slot 89R of peg 89 may be seen. The coil spring 90 may surround the peg 89. A peg aperture 92 of the component compartment bonnet 91 may be seen. The component compartment bonnet 91 may force up against the coil spring 90 when valve 60 is fully assembled. The peg aperture 92 of component compartment bonnet 91 may be where the peg 89 passes through the component compartment bonnet 91 so that the peg 89 can attach to the valve activation lever 93. The component compartment bonnet 91 may be threadably secured onto a threaded component compartment top 78T of the valve body 75.

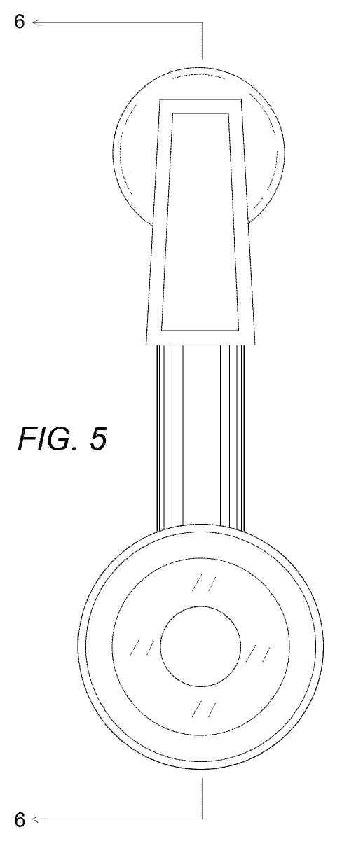

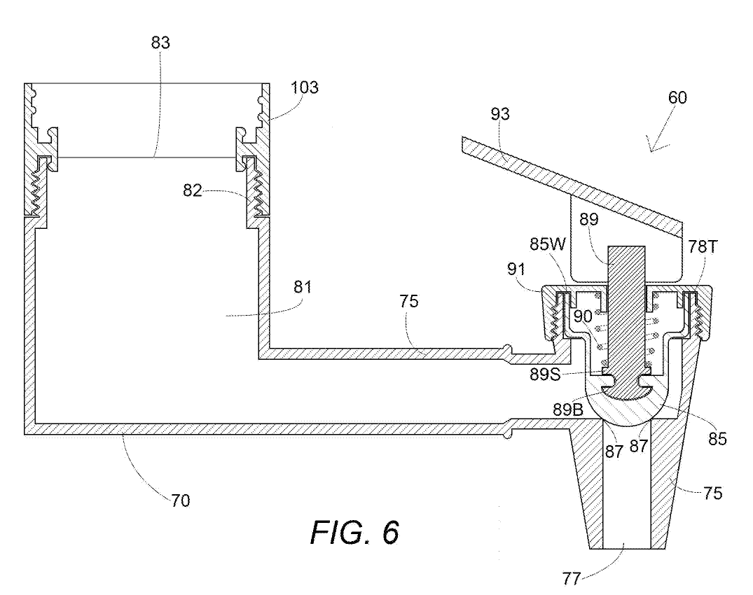

Referring to FIGS. 5 and 6, wherein FIG. 5 is an orthogonal top view of the dispenser of FIG. 2 and FIG. 6 is sectional view taken along section lines 6-6 of FIG. 5, the bottle union 103 may be attached to the threaded base top 82. The valve activation lever 93 may move the peg base 89B, which may move the seat cup 85 upward by pulling the peg 89 further to the outside of the component compartment bonnet 91 when the valve activation lever 93 is activated. The coil spring 90 may rest on the spring base 89S of the peg 89, and push up against the component compartment bonnet 91 which may urge the seat cup 85 downward against a sealing seat 87 when the valve activation lever 93 is in a resting position as may be seen. The sealing seat 87 may be in liquid communication with the base inlet port 83, and the valve body outlet port 77. The component compartment bonnet 91 may be contiguous with the seat cup wall 85W to prevent any liquid leakage, and may be threadably secured onto the component compartment top 78T. The walled base, the reservoir 81 and the valve body outlet port 77 of the valve body 75 as discussed above may also be seen.

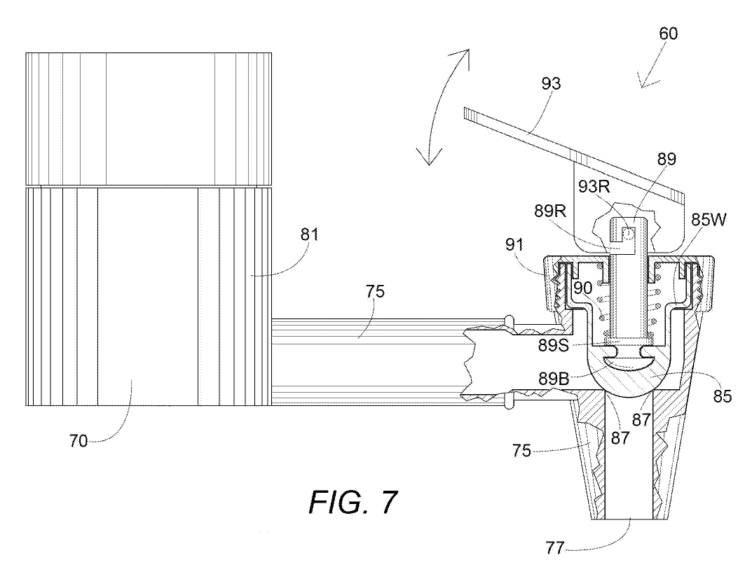

Referring to FIG. 7, the valve activation lever 93 of the dispenser may be depicted in the resting position. When the valve activation lever 93 is in the resting position, the seat cup 85 may be urged against the sealing seat 87, which may halt the flow of the liquid from the reservoir 81 from making its way through the valve body outlet port 77. The coil spring 90 may urge up against the component compartment bonnet 91 and the spring base 89S of the peg 89. With the seat cup 85 attached to the peg base 89B, the seat cup 85 may be urged against sealing seat 87 which may halt the flow of liquid through the reservoir 81. The seat cup wall 85W may be in a straight position. The right pin slot 89R may be where a right pin 93R of the valve activation lever 93 engages with the peg 89. The dispenser base 70 may be shown.

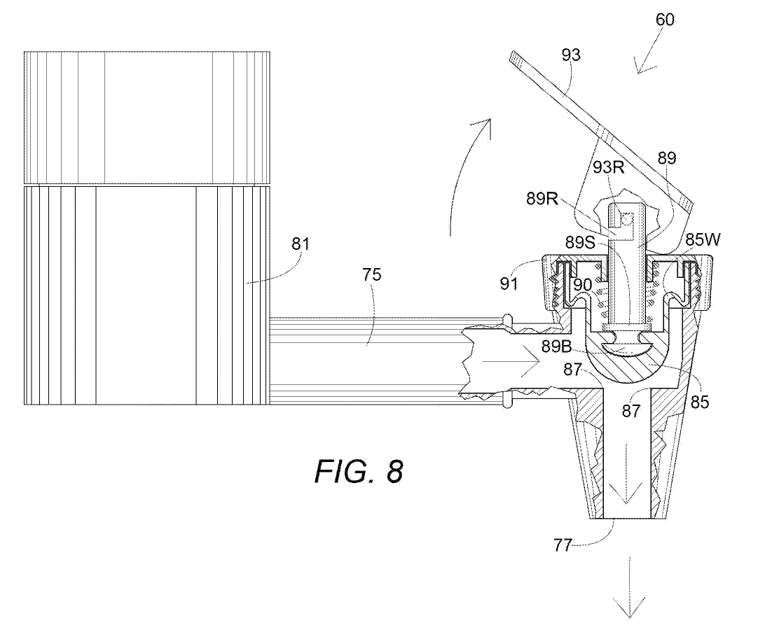

Referring to FIG. 8, the valve activation lever 93 of the valve 60 may be shown moved forward. When the valve activation lever 93 is moved forward, the right pin 93R and a left pin 93L (see FIG. 10), of the valve activation lever 93, that are inserted into the right pin slot 89R and a left pin slot 89L (see FIG. 10) of peg 89, may pull the peg base 89B of the peg 89 upward. When the peg 89 moves upward, it may pull the seat cup 85 away from the sealing seat 87 by compressing the coil spring 90 up against the coiled spring base 89S of the peg 89 and the component compartment bonnet 91. The liquid (hereinafter water) may then flow through the valve 60 from the reservoir 81 and may pass through the valve body outlet port 77. Thus, the seat cup wall 85W may be in a flexed position.

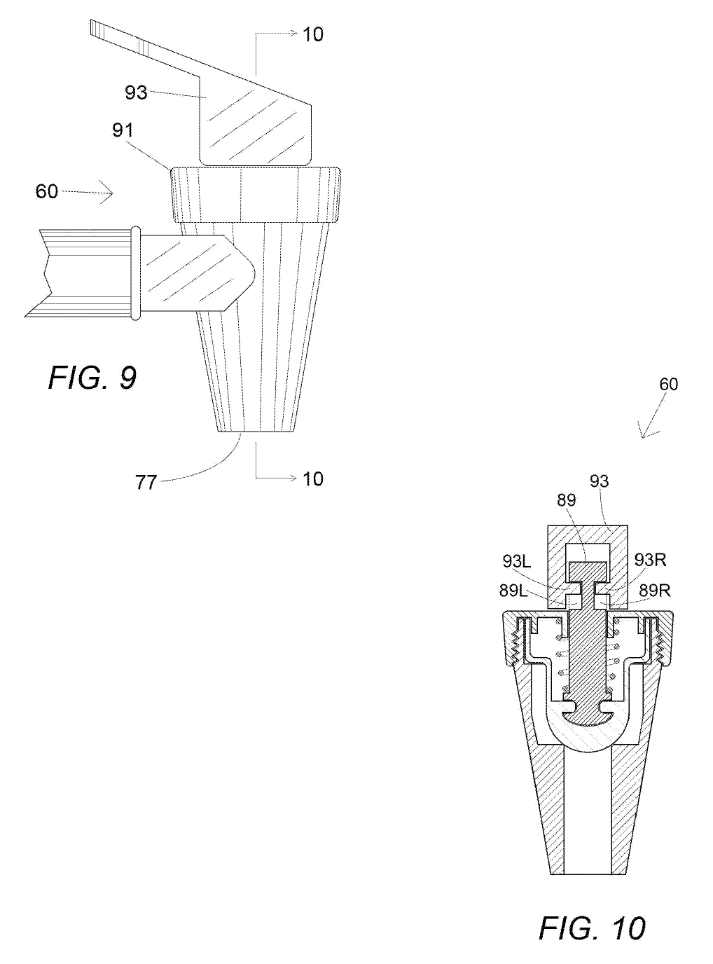

Referring to FIG. 9, the component compartment bonnet 91, the valve activation lever 93, and the valve body outlet port 77 of a broken view of the valve 60 may be shown.

Referring to FIG. 10, which is a sectional view of FIG. 9 taken at the sectioning plane in the direction indicated by section lines 10-10, the right and left pins 93R and 93L of the valve activation lever 93 may be seen along with the right and left pin slots 89R and 89L of the peg 89 showing how the valve activation lever 93 may engage the peg 89 and may activate the valve 60 in FIG. 9.

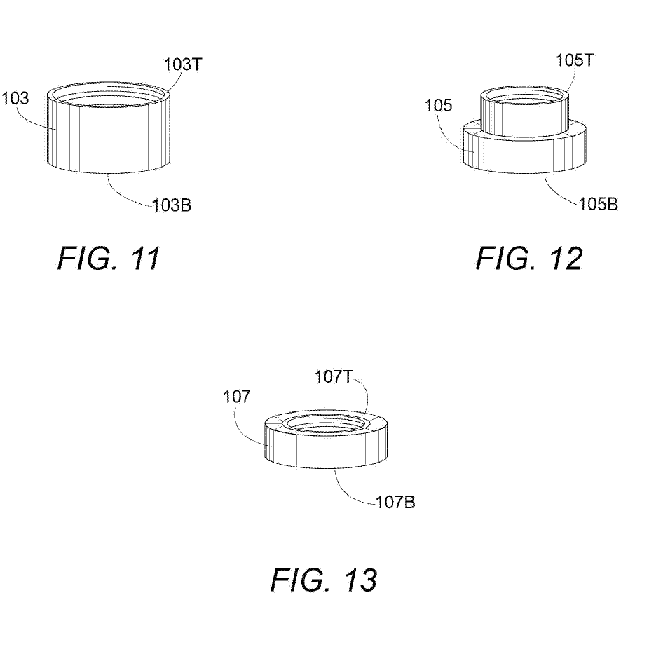

Referring to FIG. 11, a perspective view of the bottle union 103 may be seen. The bottle union 103 may have the union bottom 103B that may connect to the threaded base top 82 of the dispenser referring to FIG. 4. Threads may be formed within an interior perimeter of the bottle union 103. The threads may be used to engage threads formed on the threaded base top 82 of the dispenser. The bottle union top 103T may be formed so that the threads formed in the interior of the bottle union 103 engage with threads formed on a mouth 94M of the supply bottle 94 of FIG. 4.

Referring to FIG. 12 a perspective view of another embodiment of a bottle union, a bottle union 105 may be seen. The bottle union 105 may be described referring to FIG. 4. The same functionality of bottle union 103 may apply to bottle union 105. However, in the embodiment of FIG. 12, a top diameter of a union top 105T may be smaller than a bottom diameter of a union bottom 105B. The union top 105T may be formed to fit the threaded mouth 94M of the supply bottle 94 in which the diameter of the specific bottle mouth may be smaller than the union bottom 105B that engages with the threaded base top 82 of FIG. 4.

One more embodiment of a bottle union, the bottle union 107 may be seen in FIG. 13. The FIG. 4 view may also be used to describe the bottle union 107. The bottle union 107 may locate the threads of a union top 107T that connect to the bottle mouth 94M within the diameter of the threads of a union bottom 107B that may connect with the threads of the threaded base top 82 of the dispenser. The result may be a shorter, and more compact bottle union than the bottle union 105.

Referring to FIGS. 2, 3 and 4, the operation of the dispenser may be disclosed. To begin with, the supply bottle 94 may be placed in an upright position (upright position of the bottle 94 not shown) onto a countertop, desktop, floor or other dispensing surface. Next, the dispenser as shown if FIGS. 2 and 3 may be screwed onto the bottle mouth 94M of the upright supply bottle 94. Now the supply bottle 94 with the dispenser attached may be inverted so that the base 70 of the dispenser may be placed on a flat surface of a counter or desktop. The outlet port 77 of the valve 60 may be extended beyond the edge of a counter or desktop so that water from the supply bottle 94 may flow freely. A vent hole 97 may be required in the supply bottle 94. The supply bottle 94 may then be used to serve and dispense water by activating valve activation lever 93 of the valve 60.

The dispenser of the present embodiment provides numerous advantages. The dispenser accommodates a variety of commercial water bottles that currently have no valve dispensers. The dispenser may provide the base 70 that has a reservoir 81. The reservoir 81 may store water transferred from the supply bottle. The water transferred from the supply bottle to the reservoir 81 in the base 70 may cause the water level in the supply bottle to drop to a predetermined level. The dropped water level in the supply bottle may allow for a vent hole to be administered in the supply bottle without water escaping from the vent hole.

The dispenser generally requires no cleaning as water is dispensed directly from the single use water bottles. Spillage of water is generally unlikely from the mouth of the water bottle as the dispenser may be installed prior to lifting of the water bottle, so the water bottle wall generally will not push in and force water out of the mouth of the water bottle. Further water contamination of the bottled water is unlikely as the water is received through the valve. The dispenser may allow for smaller quantities of the 4 oz. to 24 oz. water bottles to be used since the dispenser may allow for more “gallon” or larger jugs to be used in households and may lead to an improvement in the environment.

While embodiments of the disclosure have been described in terms of various specific embodiments, those skilled in the art will recognize that the embodiments of the disclosure may be practiced with modifications within the spirit and scope of the claims. For example, other embodiments of valves/valve connections may be used to dispense water from the dispenser base. Also, the base and the valve body could take on additional geometrical shapes/sizes other than the shape of the dispenser base mentioned in the above description. Furthermore, the dispenser could be used with inverted beverage bottles in addition to inverted water bottles. Accordingly the scope should be determined not by the specific embodiments illustrated, but by their appended claims and their legal equivalents.

I claim:

1. A dispenser for delivering a liquid from an inverted supply bottle comprising:
a walled base coupled to the inverted supply bottle, the walled base having an interior reservoir in liquid communication with the inverted supply bottle, the interior reservoir storing a predetermined quantity of the liquid transferred from the inverted supply bottle; and
a valve attached to the bottom of the walled base in liquid communication with the interior reservoir, the valve controlling a flow of the liquid through the interior reservoir from the inverted supply bottle and delivering the liquid from the interior reservoir to a location outside of the walled base.

2. The dispenser of claim 1 wherein the valve comprises:
an outlet port formed in a valve body of the valve in liquid communication with the interior reservoir of the base;
a sealing seat formed in the valve body of the valve in liquid communication with the base inlet port and the valve body outlet port;
a component compartment formed in the valve body of the valve having a threaded top;
a component compartment bonnet having a center aperture, the component compartment bonnet threadably secured to the threaded compartment top;
a seat cup contiguous with the component compartment bonnet and housed within the component compartment controlling the flow of liquid through the dispenser, the liquid flowing through the valve halted when the seat cup is urged upon the sealing seat;
a peg housed within the component compartment with a base of the peg anchored within the seat cup and a slotted end of the peg extending through the aperture in the component compartment bonnet;
a coil spring surrounding the peg, the coil spring housed within the component compartment and contiguous with a spring base of the peg and the component compartment bonnet, the coil spring urging the seat cup against the sealing seat thus halting the flow of liquid from the interior reservoir when the valve is inactive; and
a valve activation lever attached to the slotted end of the peg pulling the peg further through the component compartment bonnet when activated, the valve activation lever compressing the coil spring and pulling the seat cup away from the sealing seat enabling the liquid from the interior reservoir to flow through the dispenser.

3. A dispenser for delivering a liquid from an inverted supply bottle comprising:
a walled base coupled to the inverted supply bottle with a union, the walled base having an interior reservoir in liquid communication with the inverted supply bottle, the interior reservoir storing a predetermined quantity of the liquid transferred from the inverted supply bottle; and
a valve attached to the bottom of the walled base in liquid communication with the interior reservoir, the valve controlling a flow of the liquid through the interior reservoir from the inverted supply bottle and delivering the liquid from the interior reservoir to a location outside of the walled base.

4. The dispenser of claim 3 wherein the valve comprises:
an outlet port formed in a valve body of the valve in liquid communication with the interior reservoir of the base;
a sealing seat formed in the valve body of the valve in liquid communication with the base inlet port and the valve body outlet port;
a component compartment formed in the valve body of the valve having a threaded top;
a component compartment bonnet having a center aperture, the component compartment bonnet threadably secured to the threaded compartment top;
a seat cup contiguous with the component compartment bonnet and housed within the component compartment controlling the flow of liquid through the dispenser, the liquid flowing through the valve halted when the seat cup is urged upon the sealing seat;
a peg housed within the component compartment with a base of the peg anchored within the seat cup and a slotted end of the peg extending through the aperture in the component compartment bonnet;
a coil spring surrounding the peg, the coil spring housed within the component compartment and contiguous with a spring base of the peg and the component compartment bonnet, the coil spring urging the seat cup against the sealing seat thus halting the flow of liquid from the interior reservoir when the valve is inactive; and
a valve activation lever attached to the slotted end of the peg pulling the peg further through the component compartment bonnet when activated, the valve activation lever compressing the coil spring and pulling the seat cup away from the sealing seat enabling the liquid from the interior reservoir to flow through the dispenser.

5. A dispenser for delivering a liquid from an inverted supply bottle comprising:
a walled base having a threaded top threadably secured to the inverted supply bottle with a union, the walled base having an interior reservoir in liquid communication with the inverted supply bottle, the interior reservoir storing a predetermined quantity of the liquid transferred from the inverted supply bottle; and
a valve attached to the bottom of the walled base in liquid communication with the interior reservoir, the valve controlling a flow of the liquid through the interior reservoir from the inverted supply bottle and delivering the liquid from the interior reservoir to a location outside of the walled base.

6. The dispenser of claim 5 wherein the valve comprises:
an outlet port formed in a valve body of the valve in liquid communication with the interior reservoir of the base;
a sealing seat formed in the valve body of the valve in liquid communication with the base inlet port and the valve body outlet port;
a component compartment formed in the valve body of the valve having a threaded top;
a component compartment bonnet having a center aperture, the component compartment bonnet threadably secured to the threaded compartment top;
a seat cup contiguous with the component compartment bonnet and housed within the component compartment controlling the flow of liquid through the dispenser, the liquid flowing through the valve halted when the seat cup is urged upon the sealing seat;
a peg housed within the component compartment with a base of the peg anchored within the seat cup and a slotted end of the peg extending through the aperture in the component compartment bonnet;
a coil spring surrounding the peg, the coil spring housed within the component compartment and contiguous with a spring base of the peg and the component compartment bonnet, the coil spring urging the seat cup against the sealing seat thus halting the flow of liquid from the interior reservoir when the valve is inactive; and
a valve activation lever attached to the slotted end of the peg pulling the peg further through the component compartment bonnet when activated, the valve activation lever compressing the coil spring and pulling the seat cup away from the sealing seat enabling the liquid from the interior reservoir to flow through the dispenser.
